(19) United States
(12) Patent Application Publication
(10) Pub. No.: US 2018/0209161 A1
(43) Pub. Date: Jul. 26, 2018

(54) POOL CLEANING DEVICE

(71) Applicant: Benjamin Fertic, Belleair, FL (US)

(72) Inventor: Benjamin Fertic, Belleair, FL (US)

(21) Appl. No.: 15/920,118

(22) Filed: Mar. 13, 2018

Related U.S. Application Data
(63) Continuation-in-part of application No. 15/071,583, filed on Mar. 16, 2016, now Pat. No. 9,938,742.
(60) Provisional application No. 62/140,806, filed on Mar. 31, 2015.

(51) Int. Cl. E04H 4/16; B08B 1/00

(52) U.S. Cl. CPC E04H 4/1654; B08B 1/002

(57) ABSTRACT

A pool cleaning device includes a motorized debris collection member having a forward displacement unit connected thereto. The debris collection member includes a generally rectangular-shaped frame having a mesh net suspended therefrom. A drive unit is positioned along the frame and includes an electric motor, wheels and a power source. The forward displacement unit includes a leading edge member having a plurality of protrusions for disrupting debris located along a pool body. The leading edge member is suspended between a pair of extension arms which also are connected to the frame. A tensioning mechanism is positioned between each arm and the frame and secures the leading edge at a resting location that is above the frame and net. A second net is removably positioned along the top surface of the frame.

### CROSS-REFERENCE TO RELATED APPLICATIONS

This application claims the benefit of U.S. Application Ser. No. 62/140,806 filed on Mar. 31, 2015, and U.S. application Ser. No. 15/701,583 filed on Mar. 16, 2016, the contents of each of which are incorporated herein by reference.

### TECHNICAL FIELD

The present invention relates generally to underwater equipment, and more particularly to a pool cleaning device.

### BACKGROUND

The statements in this section merely provide background information related to the present disclosure and may not constitute prior art.

There are many known pool cleaning devices. Some of the most popular devices include the automated cleaners which are connected to the pool equipment by a hose, and utilize the equipment to generate suction for removing dirt from a pool floor. Another common example is a pole mounted vacuum, which uses similar components but is manually positioned along the pool body by a user. More recently, there has been the advent of so called “leaf-eating” devices which do not require a physical connection to the pool equipment, but rather utilize water from a garden hose to create a disturbance that moves large accumulations of leaves from the pool body into the device.

Although useful in their own right, each of these devices tends to be relatively expensive and also relies on an external source to perform their jobs. Accordingly, the need exists for a pool cleaning device that can effectively remove debris from any body of water, without suffering from the drawbacks of the above noted devices.

### SUMMARY OF THE INVENTION

The present invention is directed to a pool cleaning device. One embodiment of the present invention can include a motorized debris collection member having a forward displacement unit connected thereto. The debris collection member can include a generally rectangular-shaped frame having a mesh net suspended therefrom. A drive unit can be positioned along the rear wall of the frame and can include an electric motor and wheels that propel the frame in a forward direction. A power source can be positioned along the front end of the frame. The forward displacement unit can include a leading edge member having a plurality of protrusions for disrupting debris located along a pool body. The leading edge is connected to a pair of extension arms along each end, and the extension arms are connected to the frame.

In another embodiment, one or more tensioning mechanisms are provided to secure the leading edge at a resting location that is above the frame and net. As the device moves along the ground, the leading edge disrupts debris which is then captured by the frame and net.

In yet another embodiment, a second net is removably positioned along the top surface of the frame, the second net working in conjunction with the first net to form a pocket area for trapping collected debris.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a pool cleaning device that is useful for understanding the inventive concepts disclosed herein.

FIG. 2 is a perspective view of the debris collection member of the pool cleaning device in accordance with one embodiment of the invention.

FIG. 3 is a side view of the forward displacement unit of the pool cleaning device in accordance with one embodiment of the invention.

FIG. 4 is a perspective view of the pool cleaning device in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the terms “pivotally connected,” “rotatably secured,” and derivatives thereof shall be used interchangeably to describe a situation wherein two or more objects are joined together in a manner that allows one or both of the objects to pivot and/or rotate, respectively, about or in relation to the other object. Several nonlimiting examples include a shaft and bearings assembly, traditional single hinge mechanisms, adjustable position locking hinges, pivoting couplers, and/or swivel flanges, for example.

As described herein, the terms “connector,” “complementary connector” and derivatives thereof can include any number of different elements capable of securing two items together in either a permanent or nonpermanent manner. Several nonlimiting examples include opposing strips of hook and loop material (i.e. Velcro®), magnetic elements, tethers such as straps and ties, and compression fittings such as hooks, snaps and buttons, for example. Each illustrated connector and complementary connector can be permanently secured to the illustrated portion of the device via a permanent sealer such as glue, adhesive tape, or welds, for example.

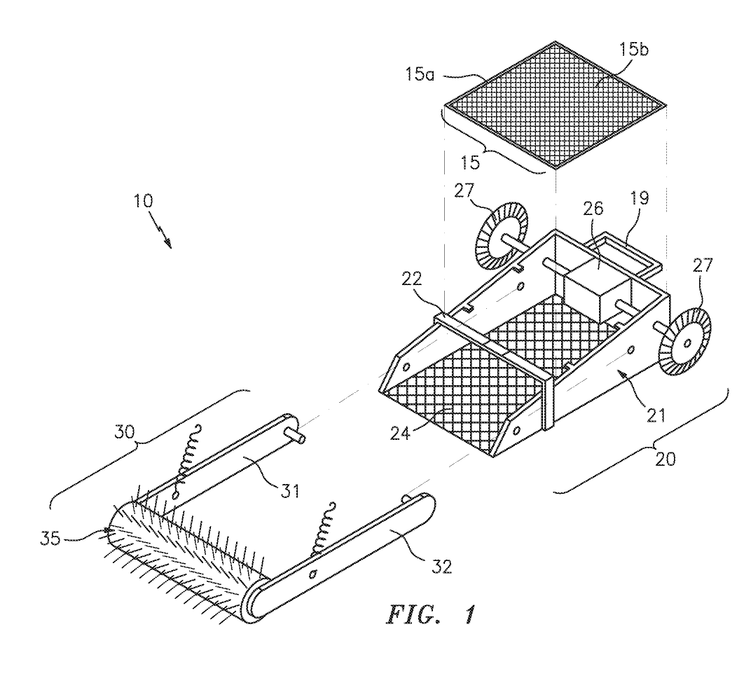

FIGS. 1-4 illustrate various embodiments of a pool cleaning device. Although described as including particular construction elements and materials, and as for being used in conjunction with a swimming pool, the inventive concepts disclosed herein are not so limiting. In this regard, the below described device can include any number of different shapes, sizes, construction materials and/or components, as will be useful for engaging debris or other such matter located within any body of water.

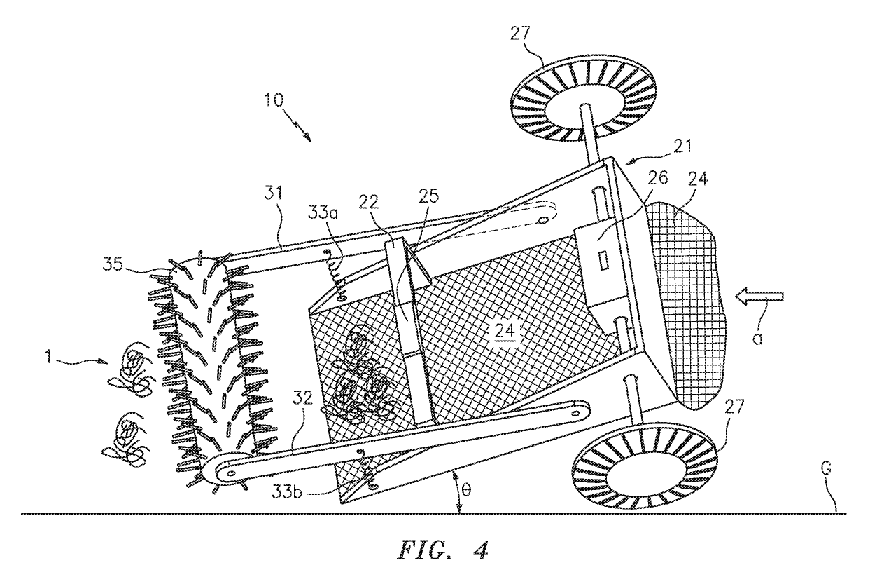

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 4.

FIG. 1 illustrates an exploded parts view of one embodiment of a pool cleaning device 10 that is useful for understanding the inventive concepts disclosed herein. As shown, the device 10 can include, essentially, a motorized main body member 20, and a forward displacement unit 30.

The removable debris capture net 15 can include a semi-rigid frame portion 15a and net portion 15b. The net 15 can include a shape and size that is complementary to the shape and size of a portion of the main body member 20, and can be removably secured to the top end of the member via hardware such as clips 5, for example. As will be described below, the optional net 15 can work with the main body net 24 to create a pocket area into which debris from a body of water can be captured.

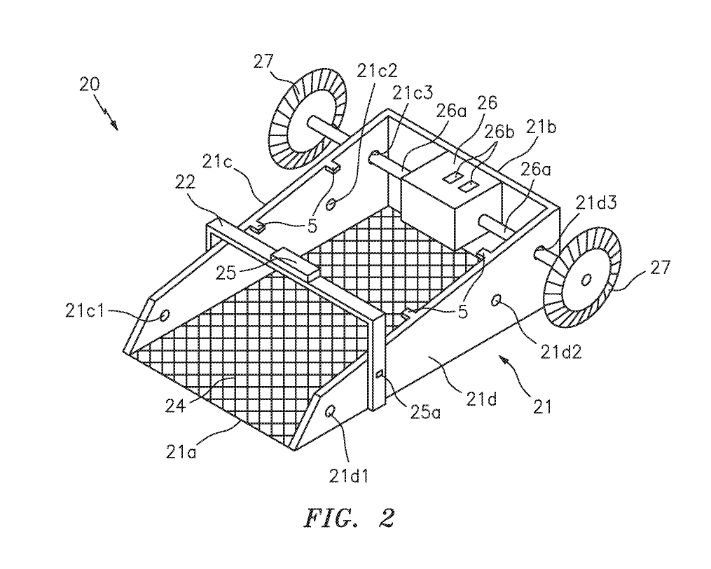

As shown best in FIG. 2, the main body member can include a frame 21 having a front wall 21a, a rear wall 21b, and a pair of side walls 21c and 21d. A support beam 22 can be positioned across the top surface of the main body and can extend between the side walls 21c and 21d. In one embodiment, a handle 19 can be positioned along the main body to facilitate removal by a hook or other grasping element positioned onto the end of a pole.

As shown, a pair of front openings 21c1 and 21d1 can be disposed along each of the side walls to receive the springs 33a and 33b described below. Likewise, additional openings 21c2 and 21d2 can be disposed along each of the side walls to receive connectors 6 for mating the frame with the extension arms of the forward displacement unit. Finally, axle apertures 21c3 and 21d3 can be disposed along each of the side walls adjacent to the rear wall 21b.

The main body frame 21 can be constructed from any number of lightweight, rigid and durable materials that are suitable for prolonged exposure to water. In the preferred embodiment, the frame can be constructed from a single piece of reinforced polymer plastic, for example; however, many other construction materials are also contemplated. Although illustrated with regard to a particular shape, those of skill in the art will recognize that the main body can include any number of different shapes and sizes.

A net 24 can be secured across each wall of the frame 21 in accordance with known manufacturing techniques. In the preferred embodiment, nets 15 and 24 can each be constructed from a fine nylon-mesh fabric; however, any number of other materials having excellent tensile strength that are suitable for prolonged exposure to water are also contemplated. In one embodiment, the net 24 can extend below the bottom surface of the frame. In this regard, as the frame moves the net through the pool, the net can function as a scoop for trapping any debris such as leaves, dirt, sticks and insects, for example, while allowing water to pass therethrough. Of course, other embodiments wherein the net 24 does not extend beneath the frame and/or is secured to the frame in a taught manner are also contemplated.

A drive unit can function to propel the device along a body of water, so as to collect debris in an autonomous manner. In the preferred embodiment, the drive unit can include a power source 25 that is electrically connected to a motor 26 that is positioned along the rear wall of the frame 21b. As shown, the motor can be positioned within a housing, and can be connected to a set of wheels 27 via axle's 26a that extend through apertures 21c3 and 21d3.

As described herein, the motor 26 can include any type of electric motor capable of functioning as described herein. One suitable example of a motor 26 includes the model N56 underwater electric motor that is commercially available from Jirun Electric Machine Co, for example; however other motors are also contemplated. In either instance, the motor can be connected to any number of different gears located within the motor housing that can engage the axle's, in order to allow the wheels to propel the device in a forward direction (i.e., toward the front wall 21a). The operation of the motor can be controlled by one or more actuators 26b, such as an ON and OFF button, for example.

As described herein, the power source 25 can include, comprise or consist of one or more direct current (DC) batteries capable of providing the necessary power requirements to the motor 26. In the preferred embodiment, the support beam 22 can include an accessible watertight cavity into which the batteries can be installed and replaced as needed. As described herein, the batteries can preferably include lithium-ion type batteries, but other types of conventional batteries such as NiCd, NiHH, and/or alkaline batteries are also contemplated. In this regard, the batteries can be removed and replaced and/or can be rechargeable in nature. To this end, the device can include a recharging port 25a having a waterproof cover (not illustrated), in order to allow the device to be recharged between uses.

As will be described below, the location of the power source along the support beam 22 advantageously allows the weight of the batteries to apply a downward force onto the device, thus providing useful tension to the forward displacement unit.

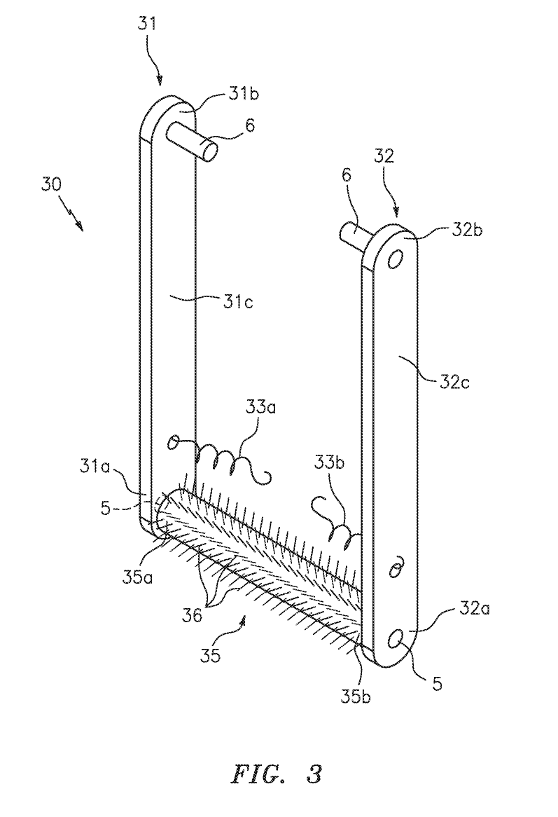

FIG. 3 illustrates one embodiment of the forward displacement unit 30, that includes first and second extension arms 31 and 32, that extend outward from a leading edge member 35. As will be described below, the extension arms 31 and 32 can function to position the leading edge member 35 a set distance from the front wall of the frame 21a, so as to allow the leading edge member to disrupt debris on the pool floor for capture by the net 24.

As shown, each extension arm 31 and 32 can include an elongated member having a first end 31a and 32a, a second end 31b and 32b, and a middle section 31c and 32c, respectively. Each of the arms can be constructed from any number of rigid materials such as plastic, for example. Connectors 6 can be positioned along the second ends of the arms 31b and 32b for engaging the openings 21c2 and 21d2, respectively. A pair of tensioning mechanisms 33a and 33b such as springs, for example, can be affixed along the middle sections of each of the extension arms 31c and 32c, respectively, and can function to engage the frame openings 21c1 and 21d1, as described below. Of course, the device is not limited to the use of any particular type of connector, openings and/or coiled springs, as any number of other devices capable of performing the described functionality are also contemplated. For example, in one embodiment, the tensioning mechanisms 33a and 33b can include commercially available adjustable springs, so as to allow a user to adjust the tension applied by the mechanism.

The leading edge member 35 can also include an elongated member that is preferably constructed from rigid plastic. The leading edge member can include a first end 35a and a second end 35b that is connected to the first ends of the extension arms 31a and 32a, respectively, so as to position the leading edge at a generally orthogonal angle to each of the arms. The leading edge can be either permanently or removably secured to the extension arms utilizing any type of connectors 5.

The leading edge 35 can include any number of different shapes such as the illustrated cylindrical shape, for example, which can rub or roll along the pool bottom. Additionally, the leading edge can include any number of protrusions 36 such as rubber nubs, for example, which can be arranged into any pattern so as to interact with the water and the pool bottom to create an updraft/vortex motion within the water as the leading edge moves across the pool floor. Such a feature can allow the momentum of the device to physically lift debris from the pool floor wherein it can be captured by the net. Moreover, the leading edge member can include a fixed orientation (e.g., does not move) or can be rotatably secured to the extension arms so as to roll along the pool body (e.g., rotatably secured).

In another embodiment, the protrusions along the leading edge can comprise a plurality of bristles which can scrape the pool floor. Such a feature can allow the leading edge to also act as a brush which can disrupt not only debris, but also fine sand and dirt that would traditionally only be captured by a vacuum device.

Although described as including a single leading edge member, other embodiments are contemplated wherein any number of different leading edge members can be utilized with the other device components. Such members can be sold separately, or can be included as a kit with the device itself. In either instance, such a feature can allow a user to interchangeably utilize any number of different leading edges, each of which being constructed to include any number of different shapes, sizes (e.g., diameters) and construction materials that are designed to perform different jobs and/or to be utilized with different pool surfaces such as concrete, marcite, diamond finish, fiberglass, and/or vinyl (typically used for above ground pools), for example.

FIG. 4 illustrates one embodiment of the assembled pool cleaning device 10, wherein the extension arms and springs are secured to the frame 21. As shown, when the device is running along the bottom surface G of the body of water, the leading edge 35 can be in direct contact with the surface G, and the frame member 21 can be oriented at an angle θ of between approximately 15° and 90° relative to the surface G. Of course, a user can adjust this angle by varying the tension of the springs.

In operation, once the motor 26 is in the ON operating state, the wheels 27 can propel the device in a forward direction (see arrow a), at which time the leading edge 35 can make contact with and debris 1 on the pool floor. At this time, the irregular and hydrodynamicly unfriendly protrusions along on the leading edge function to agitate the water as it engages the pool body G, thus causing a disturbance which acts to lift the debris from the pool floor where it is immediately captured by the net(s) 24 and/or 15.

In this manner, the weight of the power source 25 on the frame support 22 maintains a steady downward force onto the front portion of the frame, and the springs located along each of the extension arms function to maintain a steady pressure on the leading edge member. These components function together to maintain the frame/net at the optimum angle θ for debris recovery. The optimal angle will typically be between 15 and 90 degrees of movement of the extension arms relative to the frame wall to which they are attached.

Accordingly, the above described pool cleaning device provides a new and innovative device that is capable of effectively removing debris from a body of water, without requiring a hose or vacuum system.

As described herein, one or more elements of the pool cleaning device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A pool cleaning device, comprising:
a frame having a front wall, a rear wall and a pair of side walls that define a central opening;
a net that is in communication with the frame and is disposed within the central opening;
a drive unit that is positioned along the frame, said drive unit functioning to selectively propel the frame in a forward direction;
a first and second extension arms that are in communication with the frame, each of the arms including a first end that extend outward from the front wall of the frame; and
a leading edge member that is positioned between the first ends of the first and second extension arms.

2. The device of claim 1, wherein the drive unit includes:
an electric motor that is secured onto one of the frame walls; and
a pair of wheels that are in communication with the electric motor, said pair of wheels being positioned adjacent to an outside surface of the frame.

3. The device of claim 2, further comprising:
a support beam that is extends between the pair of side walls; and
a power unit that is secured onto the support beam and is in electrical communication with the electric motor.

4. The device of claim 1, wherein the net includes a size that extends beneath the frame.

5. The device of claim 1, wherein the net is secured taught to each wall, and does not extend beneath the frame.

6. The device of claim 1, further comprising:
a first tensioning mechanism that is in communication with each of the first extension arm and one of the frame side walls; and
a second tensioning mechanism that is in communication with each of the second extension arm and the other frame side wall.

7. The device of claim 6, wherein the tensioning mechanisms function to limit a rotation of the first and second extensions arms to a range of between approximately 15 and 90 degrees relative to the frame side wall to which the first and second extension arms are attached.

8. The device of claim 6, wherein each of the first and second tensioning mechanisms comprise a spring.

9. The device of claim 8, wherein the spring comprises:
an adjustable tension spring.

10. The device of claim 1, further comprising:
a plurality of protrusions that are disposed along the leading edge member.

11. The device of claim 10, wherein the plurality of protrusions include bristles forming a brush.

12. The device of claim 1, wherein the leading edge member is fixedly connected to each of the first and second extension arms.

13. The device of claim 1, wherein the leading edge member is rotatably secured between the first and second extension arms, and is configured to roll along a pool body.

14. The device of claim 1, wherein the first and second extension arms each include a second end that is pivotally secured to one of the pair of side walls of the frame at a location adjacent to the rear wall.

15. The device of claim 1, further comprising:
a second net device having a shape and size that is complementary to a portion of the frame, said second net being configured to be removably secured to a top end of the frame.
